(19) United States
(12) Patent Application Publication
(10) Pub. No.: US 2025/0029398 A1
(43) Pub. Date: Jan. 23, 2025

(54) METHOD AND APPARATUS FOR ESTIMATING PARKING SPACE GRADIENT

(71) Applicants: HYUNDAI MOTOR COMPANY, Seoul (KR); Kia Corporation, Seoul (KR)

(72) Inventor: Deuk Hyeon KIM, Seoul (KR)

(73) Assignees: HYUNDAI MOTOR COMPANY, Seoul (KR); Kia Corporation, Seoul (KR)

(21) Appl. No.: 18/519,362

(22) Filed: Nov. 27, 2023

(30) Foreign Application Priority Data
Jul. 19, 2023 (KR) 10-2023-0094096

(51) Int. Cl. G06V 20/58; G06T 5/00; G06T 7/60; G06T 7/73; G06V 10/44

(52) U.S. Cl. CPC G06V 20/586; G06T 5/00; G06T 7/60; G06T 7/73; G06V 10/44; G06T 2207/30264

(57) ABSTRACT

An apparatus for estimating a parking space gradient includes a parking space detection module that recognizes a type of a parking space based on an image captured by an image capturing device and recognizes a location of the parking space by detecting a plurality of key points corresponding to the parking space and a gradient estimation module that obtains angle information formed by the key points in the type of the parking space, estimates a rotation matrix based on estimation conditions previously set according to the angle information and the type of the parking space, and estimates a gradient of the parking space using the estimated rotation matrix and a predetermined reference rotation matrix.

### CROSS-REFERENCE TO RELATED APPLICATION

The present application claims priority to Korean Patent Application No. 10-2023-0094096, filed on Jul. 19, 2023, the entire contents of which is incorporated herein for all purposes by this reference.

### BACKGROUND OF THE PRESENT DISCLOSURE

### Field of the Present Disclosure

The present disclosure relates to a technology for estimating the gradient of a parking space, and more specifically, to a method and apparatus for estimating the gradient of a parking space based on key points corresponding to the parking space detected through an image.

### Description of Related Art

With the recent advancement of the technology, vehicles capable of autonomous driving and autonomous parking have been developed and distributed. Generally, in vehicles provided with an autonomous parking function, when a driver activates an autonomous parking function through a separate switch operation or execution command, a vehicle system searches for a parking space for parking, provides parking route guidance, and operates the vehicle for parking to perform parking.

The technology for estimating a location of a parking space based on parking lines is highly dependent on camera image recognition performance, and when a parking space exists on a sloping road surface, it is difficult to estimate an exact parking space location, which may deteriorate autonomous parking control performance.

A technology for estimating the gradient of a parking space according to a conventional technology estimates the gradient using values of camera calibration which is performed under the assumption that the road surface on which the parking space exists is on the same plane.

However, in a real environment, parking spaces have different gradients, which may cause deterioration of autonomous parking control performance.

Therefore, a method is needed to improve autonomous parking control performance by estimating the gradient for each parking space.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and apparatus for estimating a gradient of a parking space based on key points corresponding to a parking space detected through an image.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for estimating a parking space gradient includes a parking space detection module that recognizes a type of a parking space based on an image captured by an image capturing device and recognizes a location of the parking space by detecting a plurality of key points corresponding to the parking space and a gradient estimation module that obtains angle information formed by the key points in the type of the parking space, estimates a rotation matrix based on estimation conditions previously set according to the angle information and the type of the parking space, and estimates a gradient of the parking space using the estimated rotation matrix and a predetermined reference rotation matrix.

According to an exemplary embodiment of the present disclosure, the parking space detection module may detect two start points from an entrance line of the parking space and two end points from an end line of the parking space as the key points, and recognize the location of the parking space using the key points including the two start points and the two end points.

According to an exemplary embodiment of the present disclosure, the gradient estimation module may obtain a first angle information formed by a first parking line connecting a first start point among the two start points and a first end point among the two end points and the entrance line and a second angle information formed by a second parking line connecting a second start point among the two start points and a second end point among the two end points and the entrance line.

According to an exemplary embodiment of the present disclosure, the gradient estimation module may estimate the rotation matrix so that a difference between the first angle information and the second angle information converges to a preset minimum value range and the first angle information and the second angle information converge to a right angle in a situation that the type of the parking space is orthogonal/parallel or the first angle information and the second angle information are obtuse angle and acute angle or acute angle and obtuse angle.

According to an exemplary embodiment of the present disclosure, the gradient estimation module may estimate the rotation matrix so that a difference between the first angle information and the second angle information converges to a preset minimum value range and the first angle information and the second angle information are in a preset angle range in a situation that the type of the parking space is oblique or the first angle information and the second angle information are acute angle and acute angle or obtuse angle and obtuse angle.

According to an exemplary embodiment of the present disclosure, the gradient estimation module may estimate the rotation matrix so that an absolute value that differs from the first angle information by 90-degrees and an absolute value that differs from the second angle information by 90-degrees are in a range of between 10 degrees and 60 degrees.

According to an exemplary embodiment of the present disclosure, the parking space detection module may recognize the type of the parking space by recognizing the parking space through restoring at least a portion of a parking line that has been lost, in a situation that the at least a portion of the parking line of the parking space is lost.

According to an exemplary embodiment of the present disclosure, the parking space detection module may recognize a type of a virtual parking space by recognizing the virtual parking space using surrounding information including information on a parked vehicle.

According to an exemplary embodiment of the present disclosure, the parking space detection module may recognize the virtual parking space by considering a location of a parking stopper and a location of the parked vehicle, in a situation that the parking stopper is detected.

According to an exemplary embodiment of the present disclosure, the reference rotation matrix may be a rotation matrix for a case where there is no gradient of a road surface, and the gradient estimation module may estimate the gradient of the parking space based on a difference between the estimated rotation matrix and the reference rotation matrix.

According to an aspect, a method for estimating a parking space gradient includes recognizing a type of a parking space based on an image captured by an image capturing device and recognizing a location of the parking space by detecting a plurality of key points corresponding to the parking space, obtaining angle information formed by the key points in the type of the parking space, estimating a rotation matrix based on estimation conditions previously set according to the angle information and the type of the parking space, and estimating a gradient of the parking space using the estimated rotation matrix and a predetermined reference rotation matrix.

According to an exemplary embodiment of the present disclosure, the recognizing of the location of the parking space may include detecting two start points from an entrance line of the parking space and two end points from an end line of the parking space as the key points, and recognizing the location of the parking space using the key points including the two start points and the two end points.

According to an exemplary embodiment of the present disclosure, the obtaining of the angle information includes obtaining a first angle information formed by a first parking line connecting a first start point among the two start points and a first end point among the two end points and the entrance line and obtaining a second angle information formed by a second parking line connecting a second start point among the two start points and a second end point among the two end points and the entrance line.

According to an exemplary embodiment of the present disclosure, the estimating of the rotation matrix may include estimating the rotation matrix so that a difference between the first angle information and the second angle information converges to a preset minimum value range and the first angle information and the second angle information converge to a right angle in a situation that the type of the parking space is orthogonal/parallel or the first angle information and the second angle information are obtuse angle and acute angle or acute angle and obtuse angle.

According to an exemplary embodiment of the present disclosure, the estimating of the rotation matrix may include estimating the rotation matrix so that a difference between the first angle information and the second angle information converges to a preset minimum value range and the first angle information and the second angle information are in a preset angle range in a situation that the type of the parking space is oblique or the first angle information and the second angle information are acute angle and acute angle or obtuse angle and obtuse angle.

According to an exemplary embodiment of the present disclosure, the estimating of the rotation matrix may include estimating the rotation matrix so that an absolute value that differs from the first angle information by 90-degrees and an absolute value that differs from the second angle information by 90-degrees are in a range of between 10 degrees and 60 degrees.

According to an exemplary embodiment of the present disclosure, the recognizing of the location of the parking space may include recognizing the type of the parking space by recognizing the parking space through restoring at least a portion of a parking line that has been lost, in a situation that the at least a portion of the parking line of the parking space is lost.

According to an exemplary embodiment of the present disclosure, the recognizing of the location of the parking space may include recognizing a type of a virtual parking space by recognizing the virtual parking space using surrounding information including information on a parked vehicle.

According to an exemplary embodiment of the present disclosure, the recognizing of the location of the parking space may include recognizing the virtual parking space by considering a location of a parking stopper and a location of the parked vehicle, in a situation that the parking stopper is detected.

According to an exemplary embodiment of the present disclosure, the reference rotation matrix may be a rotation matrix for a case where there is no gradient of a road surface, and the estimating a gradient of the parking space may include estimating the gradient of the parking space based on a difference between the estimated rotation matrix and the reference rotation matrix.

The features briefly summarized above with respect to the present disclosure are merely exemplary aspects of the detailed description of the present disclosure described below, and do not limit the scope of the present disclosure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows a block diagram of an apparatus for estimating a parking space gradient according to an exemplary embodiment of the present disclosure;

FIG. 2 shows an example diagram for describing a process of detecting a parking space;

FIG. 3A and FIG. 3B show an example diagram for describing a process of estimating a gradient when the type of a parking space is orthogonal/parallel;

FIG. 4A and FIG. 4B show an example diagram for describing a process of estimating a gradient when the type of a parking space is oblique;

FIG. 5 shows an operational flowchart for a method for estimating a parking space gradient according to another exemplary embodiment of the present disclosure; and

FIG. 6 is a block diagram of a computing system for executing a method of estimating a parking space gradient according to another exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, with reference to the accompanying drawings, exemplary embodiments of the present disclosure will be described in detail so that those of ordinary skill in the art can easily carry out the present disclosure. However, the present disclosure may be embodied in several different forms and is not limited to the exemplary embodiments described herein.

In describing the exemplary embodiments of the present disclosure, when it is determined that a detailed description of a known configuration or function may obscure the gist of the present disclosure, a detailed description thereof will be omitted. Furthermore, in the drawings, parts that are not related to the description of the present disclosure are omitted, and similar parts are provided similar reference numerals.

It will be understood that when an element is referred to as being “connected,” “coupled,” or “fixed” to another element, it may be directly connected or coupled to the other element or intervening elements may be present. Furthermore, unless explicitly described to the contrary, the word “comprise”, “have” or “include” will be understood to imply the inclusion of stated elements but not the exclusion of any other elements.

In an exemplary embodiment of the present disclosure, terms such as first and second are used only for distinguishing one component from other components, and do not limit the order or importance of the components unless specifically mentioned. Therefore, within the scope of the present disclosure, a first element in an exemplary embodiment of the present disclosure may be referred to as a second element in another exemplary embodiment of the present disclosure, and similarly, the second element in an exemplary embodiment of the present disclosure may be referred to as the first element in another exemplary embodiment of the present disclosure.

In an exemplary embodiment of the present disclosure, distinct components are only for clearly describing theirs features, and do not necessarily mean that the components are separated. That is, a plurality of components may be integrated to form one hardware or software unit, or one component may be distributed to form a plurality of hardware or software units. Accordingly, even when not specifically mentioned, such integrated or distributed embodiments are also included in the scope of the present disclosure.

In an exemplary embodiment of the present disclosure, components described In various embodiments do not necessarily mean essential components, and some may be optional components. Accordingly, exemplary embodiments including a subset of components described in an exemplary embodiment are also included in the scope of the present disclosure. Additionally, exemplary embodiments that include other components in addition to the components described in the various exemplary embodiments of the present disclosure are also included in the scope of the present disclosure.

In an exemplary embodiment of the present disclosure, expressions of positional relationships used in the specification, such as top, bottom, left, or right, are described for convenience of description, and when the drawings shown in the specification are viewed in reverse, the positional relationships described in the specification may also be interpreted in the opposite way.

In an exemplary embodiment of the present disclosure, each of phrases such as “A or B”, “at least one of A and B”, “at least one of A or B”, “A, B or C”, “at least one of A, B and C”, and at least one of A, B, or C” may include any one of the items listed together in the corresponding phrase, or any possible combination thereof.

Embodiments of the present disclosure may clearly estimate the location of a parking space by estimating a gradient of the parking space based on key points for the parking space detected through image recognition, and thereby improve autonomous parking control performance.

Embodiments of the present disclosure may set different conditions for estimating the gradient (hereinafter referred to as “estimation conditions”) according the type of the detected parking space, for example, orthogonal/parallel/oblique or the like, and clearly estimate the gradient of the parking space using the estimation conditions according to the type of the parking space and the angle information formed by key points.

Here, parking spaces may be classified into an orthogonal/parallel type and an oblique type. When there is no gradient, the angle formed by parking lines may be orthogonal (or 90 degrees) in the orthogonal/parallel type parking space, and the angle formed by parking lines may be an obtuse angle or an acute angle in the oblique type parking space. On the other hand, when there is a gradient, two angles formed by the parking lines in the orthogonal/parallel type parking space may be (obtuse angle, acute angle) or (acute angle, obtuse angle), and the two angles formed by the parking lines in the oblique type parking space may be (acute angle, acute angle) or (obtuse angle, obtuse angle).

The two angles formed by the parking lines in the exemplary embodiment of the present disclosure will be described below in the detailed description of the present disclosure.

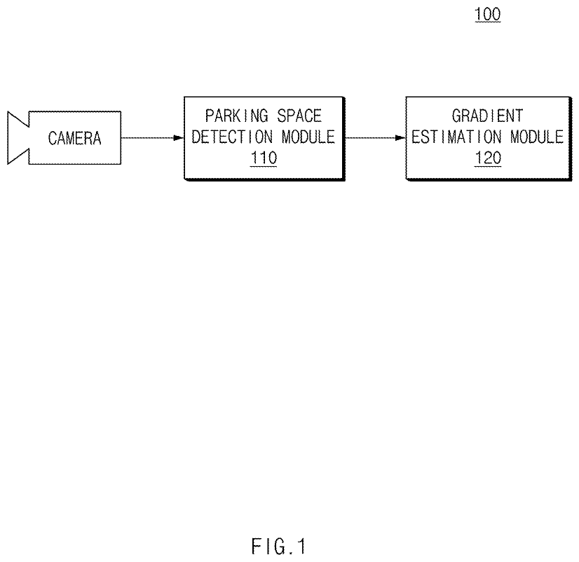

FIG. 1 shows a block diagram of an apparatus for estimating a parking space gradient according to an exemplary embodiment of the present disclosure. The apparatus for estimating a parking space gradient may be provided in an autonomous vehicle or a vehicle provided with an Advanced Driver Assistant System (ADAS).

Referring to FIG. 1, an apparatus 100 for estimating a parking space gradient according to an exemplary embodiment of the present disclosure may include a parking space detection module (or parking space detector) 110 and a gradient estimation module (or gradient estimator) 120.

The parking space detection module 110 may receive an image captured by an image capturing device, for example, a camera sensor, for example, a parking space image, and detect a parking space from a parking space image.

According to an exemplary embodiment of the present disclosure, the parking space detection module 110 may recognize a type of the parking space based on the parking space image and detect key points corresponding to the parking space to recognize the location of the parking space.

For example, the parking space detection module 110 may detect two start points from the entrance line of the parking space recognized in the parking space image and detect two end points from the end line of the recognized parking space, detect the two start point and the two end points as key points, and recognize a location of the parking space using the detected key points.

In the instant case, the key points of the parking space may be defined using 3D coordinates based on EOL (End Of Line) camera calibration.

The parking space may be a rectangular space in which all parking lines are drawn. However, in some cases, only three parking lines are drawn, in some cases, some parking lines are missing, in some cases, only two parking lines are drawn, and in some cases, parking lines are not drawn.

According to an exemplary embodiment of the present disclosure, in the case of a parking space where at least portion of the parking line is missing or absent, the parking space detection module 110 may recognize a type of the parking space by recognizing a virtual parking space through image analysis, and recognize the location of the virtual parking space by detecting key points in the virtual parking space.

According to an exemplary embodiment of the present disclosure, when at least portion of the parking line of the parking space is lost, the parking space detection module 110 may restore the at least portion of the parking line, which has been lost, using the remaining parking line or using parking line information from a nearby parking space, recognize the parking space through this to recognize a type of the parking space and the location of the parking space.

According to an exemplary embodiment of the present disclosure, the parking space detection module 110 may recognize a type of the virtual parking space by recognizing the virtual parking space using surrounding information including information on a parked vehicle. For example, the parking space detection module may be configured to determine whether a parking space is a space in which parking is possible based on information on parked vehicles and information on spaces between the parked vehicles even when there are parking spaces between the parked vehicles but there are no parking lines and recognize a corresponding space when the corresponding space is a space in which parking is possible, as a virtual parking space. In the instant case, the parking space detection module 110 may set the parking line of the virtual parking space by considering the location of the parked vehicle, the locations of wheels, and the like, and recognize the type of the virtual parking space and the location of the virtual parking space based on the set virtual parking line.

According to an exemplary embodiment of the present disclosure, when there is a parking stopper in a parking space, the parking space detection module 110 may recognize the parking stopper and may recognize a virtual parking space based on the location of the parking stopper, the locations of surrounding parked vehicles and surrounding environment information, for example, surrounding environment information obtained by LiDAR sensors, Laser sensors, ultrasonic sensors, or the like.

As described above, the parking space detection module 110 may recognize a parking space in various methods, and recognize the type of the recognized parking space and the location of the parking space based on key points.

The parking space detection module 110 may recognize parking spaces using a deep learning-based artificial intelligence network or may recognize parking spaces using image processing techniques, but is not restricted or limited to these techniques.

The gradient estimation module 120 may obtain angle information formed by key points in the type of the parking space recognized by the parking space detection module 110, estimate a rotation matrix based on preset estimation conditions according to the angle information and the type of the parking space, and estimate the gradient of the parking space using the estimated rotation matrix and a predetermined reference rotation matrix.

Here, the reference rotation matrix refers to a rotation matrix for a case where there is no gradient of the road surface, and the gradient estimation module may estimate the gradient of the parking space based on a difference between the estimated rotation matrix and the reference rotation matrix.

According to an exemplary embodiment of the present disclosure, the gradient estimation module 120 may obtain a first angle information formed by a first parking line connecting the first start point and the first end point and an entrance line and a second angle information formed by a second parking line connecting the second start point and the second end point and the entrance line with respect to the two start points and two end points included in the key points. Here, the angle information may be information related to a specific angle, or may be angle information such as an acute angle, an obtuse angle, a right angle, or the like.

According to an exemplary embodiment of the present disclosure, the gradient estimation module 120 may estimate a rotation matrix so that a difference between the first angle information and the second angle information converges to a preset minimum value range and the first angle information and the second angle information converge to a right angle when the type of the parking space is orthogonal/parallel or (first angle information, second angle information) is (obtuse angle, acute angle) or (acute angle, obtuse angle). Here, it is most desirable for the angle information difference to converge to 0. However, because errors may occur, a convergence range may be set by taking this into account, and the convergence range set as described above may be defined as the minimum value range. It should be noted that it is most desirable for the first angle information and the second angle information to converge to a right angle. However, by setting the angle information to a certain range around 90 degrees, the angle information difference converges to the minimum value range and the angle information converges to a certain range, so that the rotation matrix may also be estimated.

According to an exemplary embodiment of the present disclosure, the gradient estimation module 120 may estimate a rotation matrix so that a difference between the angle information and the second angle information converges to a preset minimum value range and the first angle information and the second angle information are in a preset angle range when the type of the parking space is oblique or (first angle information, second angle information) is (acute angle, acute angle) or (obtuse angle, obtuse angle). Here, it is most desirable for the angle information difference to converge to 0. However, because errors may occur, a convergence range may be set by taking this into account, and the convergence range set as described above may be defined as the minimum value range. Furthermore, the angle range of the first angle information and the angle range of the second angle information may be set by an individual or business operator providing the technology of the present disclosure, for example, the angle range may be 10°≤|θ−90°|≤60°, and θ is the first angle information or the second angle information.

In an exemplary embodiment of the present disclosure, the parking space detection module 110 and the gradient estimation module 120 may be implemented in a form of hardware such as at least a processor, or software, or may be implemented in a combination of hardware and software.

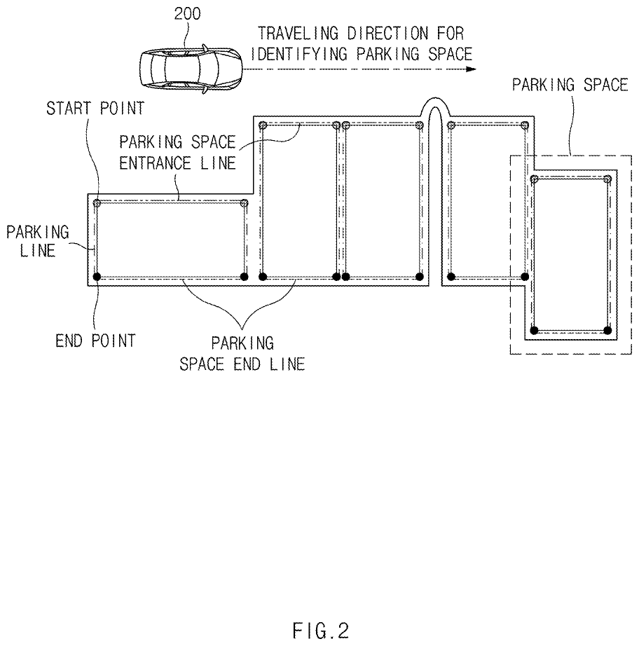

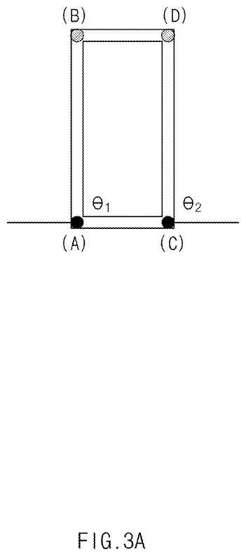

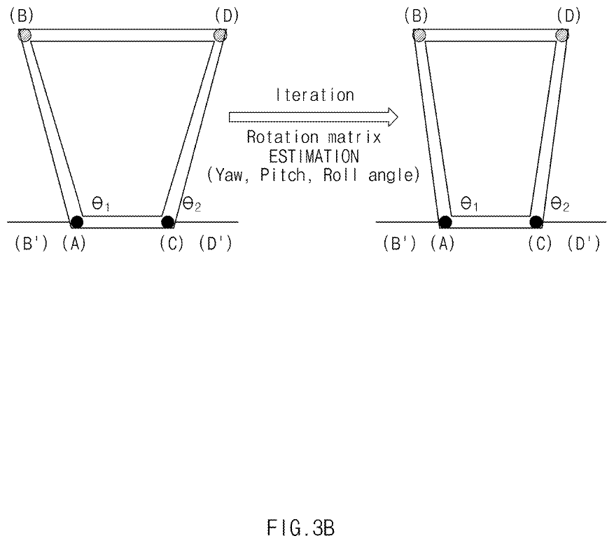

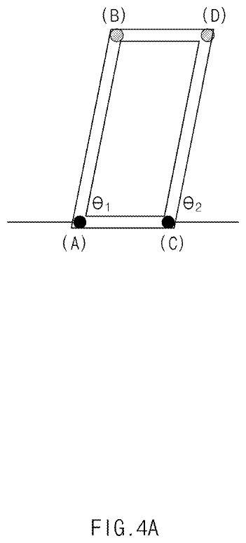

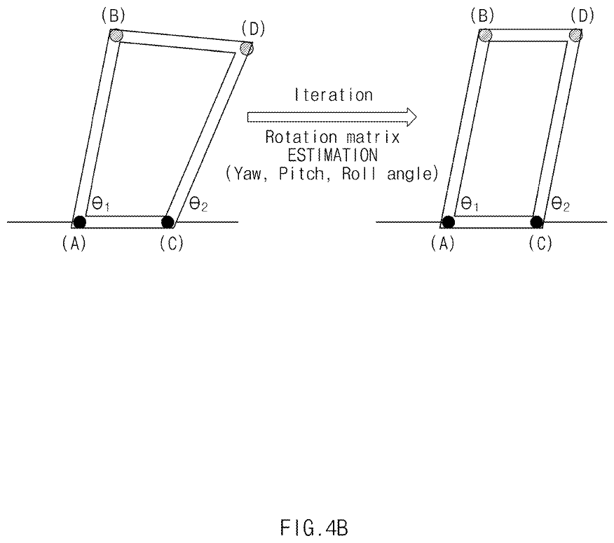

The apparatus for estimating a parking space gradient of the present disclosure will be described below in more detail with reference to FIG. 2, FIG. 3A and FIG. 3B and FIG. 4A and FIG. 4B.

FIG. 2 shows an example diagram for describing a process of detecting a parking space.

Referring to FIG. 2, a vehicle 200 may recognize each parking space by analyzing images captured by an image capture device, for example, a camera sensor, while moving in the direction of the entrance of the parking space.

In the case of FIG. 2, because the parking spaces are separated by parking lines, the parking space detection module 110 may recognize a type of a parking space by recognizing the parking lines through real-time analysis of the images and recognizing the parking space through the parking lines, and recognize the location of the parking space by detecting key points of the recognized parking space.

In the instant case, the parking space detection module 110 may detect points where the parking space entrance line and the parking lines meet as two start points, and detect points where the parking space end line and the parking lines meet as two end points, detecting four key points.

As a corresponding vehicle moves in the traveling direction to identify a parking space, the vehicle may recognize the type and location of each parking space through real-time analysis of the images. When the autonomous parking function is performed in a specific parking space, the vehicle may clearly estimate the gradient of the specific parking space to improve autonomous parking control performance.

A process of estimating a gradient will be described below with reference to FIG. 3A and FIG. 3B and FIG. 4A and FIG. 4B.

FIG. 3A and FIG. 3B show an example diagram for describing a process of estimating a gradient when the type of a parking space is orthogonal/parallel. FIG. 3A shows a case in which there is no road surface gradient, and FIB. 3B shows a case in which there is a road surface gradient.

It may be seen from FIG. 3A that, when the type of a parking space is orthogonal/parallel and there is no road surface gradient, an included angle between a first parking line connecting key points (A) and (B) and a parking space entrance line, that is, an entrance line connecting key points (A) and (C) and an included angle between a second parking line connecting key points (C) and (D) and the parking space entrance line, that is, the first angle information (θ₁) and the second angle information (θ₂) converge to 90 degrees, and a difference between the included angles, that is, |θ₁-θ₂|, converges to 0, and through this, the gradient of the parking space may be estimated as 0.

On the other hand, as shown in FIG. 3B, when the type of the parking space is orthogonal/parallel and there is a road surface gradient, there is a characteristic that the difference |θ₁-θ₂| between the included angle between the first parking line connecting key points (A) and (B) and the entrance line connecting key points (A) and (C) and the included angle between the second parking line connecting key points (C) and (D) and the parking space entrance line increases, and based on the characteristic, a rotation matrix (Yaw, Pitch, Roll angle) of the parking space in which the difference between the included angles (|θ₁-θ₂|) converges to 0 and each angle converges to 90 degrees may be estimated. In the instant case, a process of estimating a rotation matrix may be a process of repeatedly performing a process of determining whether the above-described estimation conditions are satisfied while changing the Yaw angle, Pitch angle, and Roll angle little by little, as shown in FIG. 3B, and through the present process, a rotation matrix that satisfies the estimation conditions may be estimated. In other words, the rotation matrix of the parking space may be estimated by performing an iterative process so that key points (A) and (C) are moved to (B′) and (D′). Of course, the process of estimating the rotation matrix is not restricted or limited to the iterative process, and various methods for estimating a rotation matrix satisfying the estimation conditions may be applied.

When the rotation matrix satisfying the estimation conditions is estimated through the above-described process, the gradient of the corresponding parking space, that is, a parking space of which the type is orthogonal/parallel, may be estimated based on the difference between the estimated rotation matrix and the reference rotation matrix.

FIG. 4A and FIG. 4B shows an example diagram for describing a process of estimating a gradient when the type of a parking space is oblique. FIG. 4A shows a case in which there is no road surface gradient, and FIG. 4B shows a case in which there is a road surface gradient.

It may be seen from FIG. 4A that, when the type of a parking space is oblique and there is no road surface gradient, a difference |θ₁-θ₂| between an included angle between a first parking line connecting key points (A) and (B) and an entrance line connecting key points (A) and (C) and an included angle between a second parking line connecting key points (C) and (D) and the entrance line, that is, the first angle information (θ₁) and the second angle information (θ₂) converge to 0 degrees or a minimum value range, and the first angle information (θ₁) and the second angle information (θ₂) all satisfy 10°≤|θ−90°|≤60°, and through this, the gradient of the parking space may be estimated as 0.

On the other hand, as shown in FIG. 4B, when the type of the parking space is oblique and there is a road surface gradient, there is a characteristic that the difference |θ₁-θ₂| between the included angle between the first parking line connecting key points (A) and (B) and the entrance line connecting key points (A) and (C) and the included angle between the second parking line connecting key points (C) and (D) and the parking space entrance line increases, and based on the characteristic, a rotation matrix (Yaw, Pitch, Roll angle) of the parking space in which the difference between the included angles (|θ₁-θ₂|) converges to 0 and the first angle information (θ₁) and the second angle information (θ₂) all satisfy 10°≤|θ−90°|≤60° may be estimated. In the instant case, a process of estimating a rotation matrix may be a process of iteratively performing the process of determining whether the above-described estimation conditions are satisfied while changing a yaw angle, a pitch angle, and a roll angle little by little, as shown in FIG. 4B, and through the present process, a rotation matrix that satisfies the estimation conditions may be estimated. Of course, the process of estimating the rotation matrix is not restricted or limited to the iterative process, and various methods for estimating a rotation matrix satisfying the estimation conditions may be applied.

When the rotation matrix satisfying the estimation conditions is estimated through the above-described process, the gradient of the corresponding parking space, that is, a parking space of which the type is oblique, may be estimated based on the difference between the estimated rotation matrix and the reference rotation matrix.

As described above, the apparatus for estimating a parking space gradient according to the exemplary embodiment of the present disclosure may accurately estimate a gradient for the type of each parking space based on key points corresponding to a parking space detected through an image, and improve autonomous parking control performance and quality through estimation of the gradient for each parking space.

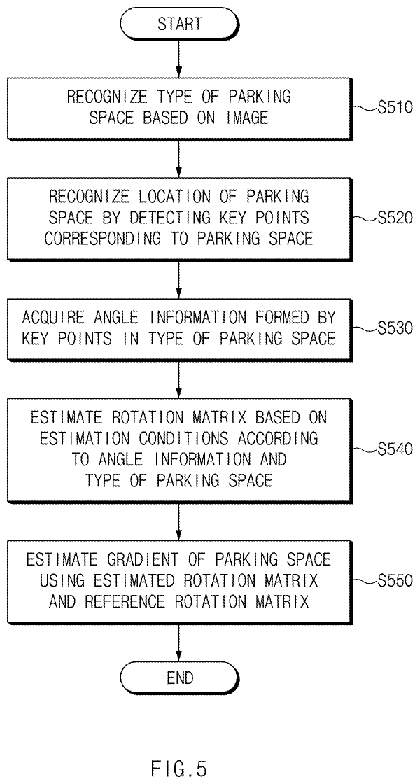

FIG. 5 shows an operational flowchart for a method for estimating a parking space gradient according to another exemplary embodiment of the present disclosure, and shows an operational flowchart performed by the apparatus of FIG. 1, FIG. 2, FIG. 3A, FIG. 3B, FIG. 4A and FIG. 4B.

Referring to FIG. 5, a method for estimating a parking space gradient according to another exemplary embodiment of the present disclosure may include recognizing the type of a parking space based on an image captured by an image capturing device and detect a plurality of key points corresponding to the parking space to recognize the location of the parking space (S510 and S520).

According to an exemplary embodiment of the present disclosure, in S510, when at least a portion of the parking line of the parking space are lost, the type of the parking space may be recognized by restoring at least a portion of the lost parking line and recognizing the parking space.

According to an exemplary embodiment of the present disclosure, S510 may include recognizing a type of the virtual parking space by recognizing the virtual parking space using surrounding information including information on a parked vehicle.

According to an exemplary embodiment of the present disclosure, S510 may include recognizing the type of a virtual parking space by recognizing the virtual parking space in consideration of the location of the parking stopper, the location of a parked vehicle, and if required, surrounding environment information when the parking stopper is detected.

According to an exemplary embodiment of the present disclosure, S520 may include detecting two start points from the entrance line of the parking space recognized in the parking space image and detecting two end points from the end line of the recognized parking space, detecting the two start point and the two end points as key points, and recognizing a location of the parking space using the detected key points.

When the type and location of the parking space are recognized through the above processes, angle information formed by key points in the type of the parking space may be obtained, and a rotation matrix of the parking space may be estimated based on preset estimation conditions according to the angle information and the type of the parking space. (S530 and S540).

According to an exemplary embodiment of the present disclosure, S530 may include obtaining a first angle information formed by a first parking line connecting the first start point and the first end point and an entrance line and a second angle information formed by a second parking line connecting the second start point and the second end point and the entrance line.

According to an exemplary embodiment of the present disclosure, S540 may include estimating a rotation matrix so that a difference between the first angle information and the second angle information converges to a preset minimum value range and the first angle information and the second angle information converge to a right angle when the type of the parking space is orthogonal/parallel or the first angle information and the second angle information are obtuse angle and acute angle or acute angle and obtuse angle.

According to an exemplary embodiment of the present disclosure, S540 may include estimating a rotation matrix so that a difference between the first angle information and the second angle information converges to a preset minimum value range and the first angle information and the second angle information are in a preset angle range, for example, 10°≤|θ−90°|−60° when the type of the parking space is oblique or the first angle information and the second angle information are acute angle and acute angle or obtuse angle and obtuse angle.

When the rotation matrix of the parking space is estimated through S540, the gradient of the parking space may be estimated using the estimated rotation matrix and a predetermined reference rotation matrix (S550).

Here, the reference rotation matrix may be a rotation matrix for a case where there is no gradient of the road surface, and S550 may include estimating the gradient of the parking space based on a difference between the estimated rotation matrix and the reference rotation matrix.

Even when a description of the method according to another exemplary embodiment of the present disclosure is omitted, the method according to another exemplary embodiment of the present disclosure may include all of the contents described in the apparatus of FIG. 1, FIG. 2, FIG. 3A, FIG. 3B, FIG. 4A and FIG. 4B, which is obvious to those skilled in the art.

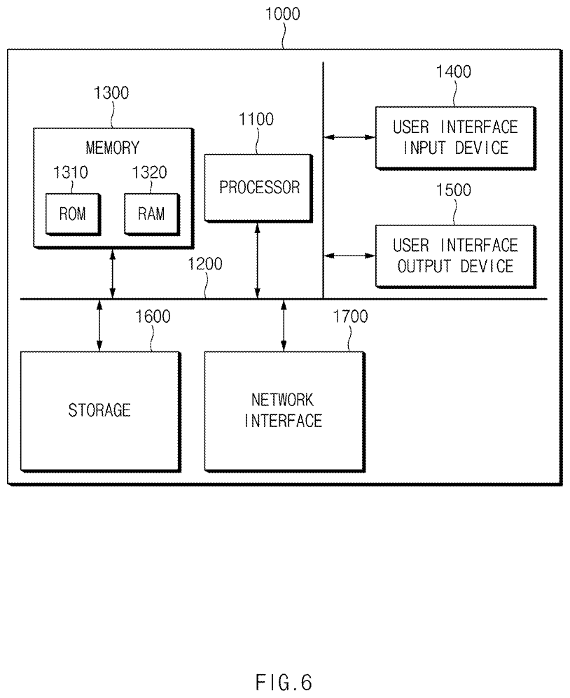

FIG. 6 is a block diagram of a computing system for executing a method of estimating a parking space gradient according to another exemplary embodiment of the present disclosure.

Referring to FIG. 6, a method of estimating a parking space gradient according to another exemplary embodiment of the present disclosure described above may be implemented through a computing system. A computing system 1000 may include at least one processor 1100, a memory 1300, a user interface input device 1400, a user interface output device 1500, storage 1600, and a network interface 1700, which are connected to each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains. Accordingly, the exemplary embodiment included in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

According to an exemplary embodiment of the present disclosure, it is possible to provide a method and apparatus for estimating the gradient of a parking space based on key points corresponding to a parking space detected through an image.

According to an exemplary embodiment of the present disclosure, it is possible to improve autonomous parking control performance and quality by estimating the gradient for each parking space.

The effects obtainable in an exemplary embodiment of the present disclosure are not limited to the aforementioned effects, and any other effects not mentioned herein will be clearly understood from the following description by those skilled in the art to which the present disclosure pertains.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for estimating a parking space gradient, the apparatus comprising:
a parking space detection module configured to recognize a type of a parking space based on an image captured by an image capturing device and recognize a location of the parking space by detecting a plurality of key points corresponding to the parking space; and
a gradient estimation module configured to obtain angle information formed by the key points in the type of the parking space, estimate a rotation matrix based on estimation conditions previously set according to the angle information and the type of the parking space, and estimate a gradient of the parking space using the estimated rotation matrix and a predetermined reference rotation matrix.

2. The apparatus of claim 1, wherein the parking space detection module is configured to detect two start points from an entrance line of the parking space and two end points from an end line of the parking space as the key points, and recognize the location of the parking space using the key points including the two start points and the two end points.

3. The apparatus of claim 2, wherein the gradient estimation module is configured to obtain a first angle information formed by a first parking line connecting a first start point among the two start points and a first end point among the two end points and the entrance line and a second angle information formed by a second parking line connecting a second start point among the two start points and a second end point among the two end points and the entrance line.

4. The apparatus of claim 3, wherein the gradient estimation module is configured for estimating the rotation matrix so that a difference between the first angle information and the second angle information converges to a preset minimum value range and the first angle information and the second angle information converge to a right angle in a situation that the type of the parking space is orthogonal/parallel or the first angle information and the second angle information are obtuse angle and acute angle or acute angle and obtuse angle.

5. The apparatus of claim 3, wherein the gradient estimation module is configured for estimating the rotation matrix so that a difference between the first angle information and the second angle information converges to a preset minimum value range and the first angle information and the second angle information are in a preset angle range in a situation that the type of the parking space is oblique or the first angle information and the second angle information are acute angle and acute angle, or obtuse angle and obtuse angle.

6. The apparatus of claim 5, wherein the gradient estimation module is configured for estimating the rotation matrix so that an absolute value that differs from the first angle information by 90-degrees and an absolute value that differs from the second angle information by 90-degrees are in a range of between 10 degrees and 60 degrees.

7. The apparatus of claim 1, wherein the parking space detection module is configured to recognize the type of the parking space by recognizing the parking space through restoring at least a portion of a parking line that has been lost, in a situation that the at least a portion of the parking line of the parking space is lost.

8. The apparatus of claim 1, wherein the parking space detection module is configured to recognize a type of a virtual parking space by recognizing the virtual parking space using surrounding information including information on a parked vehicle.

9. The apparatus of claim 8, wherein the parking space detection module is configured to recognize the virtual parking space by considering a location of a parking stopper and a location of the parked vehicle, in a situation that the parking stopper is detected.

10. The apparatus of claim 1,
wherein the reference rotation matrix is a rotation matrix for a case where there is no gradient of a road surface, and
wherein the gradient estimation module is configured for estimating the gradient of the parking space based on a difference between the estimated rotation matrix and the reference rotation matrix.

11. A method for estimating a parking space gradient, the method comprising:
recognizing, by a processor, a type of a parking space based on an image captured by an image capturing device and recognizing a location of the parking space by detecting a plurality of key points corresponding to the parking space;
obtaining, by the processor, angle information formed by the key points in the type of the parking space;
estimating, by the processor, a rotation matrix based on estimation conditions previously set according to the angle information and the type of the parking space; and
estimating, by the processor, a gradient of the parking space using the estimated rotation matrix and a predetermined reference rotation matrix.

12. The method of claim 11, wherein the recognizing of the location of the parking space includes detecting two start points from an entrance line of the parking space and two end points from an end line of the parking space as the key points, and recognizing the location of the parking space using the key points including the two start points and the two end points.

13. The method of claim 12, wherein the obtaining of the angle information includes obtaining a first angle information formed by a first parking line connecting a first start point among the two start points and a first end point among the two end points and the entrance line and obtaining a second angle information formed by a second parking line connecting a second start point among the two start points and a second end point among the two end points and the entrance line.

14. The method of claim 13, wherein the estimating of the rotation matrix includes estimating the rotation matrix so that a difference between the first angle information and the second angle information converges to a preset minimum value range and the first angle information and the second angle information converge to a right angle in a situation that the type of the parking space is orthogonal/parallel or the first angle information and the second angle information are obtuse angle and acute angle or acute angle and obtuse angle.

15. The method of claim 13, wherein the estimating of the rotation matrix includes estimating the rotation matrix so that a difference between the first angle information and the second angle information converges to a preset minimum value range and the first angle information and the second angle information are in a preset angle range in a situation that the type of the parking space is oblique or the first angle information and the second angle information are acute angle and acute angle or obtuse angle and obtuse angle.

16. The method of claim 15, wherein the estimating of the rotation matrix includes estimating the rotation matrix so that an absolute value that differs from the first angle information by 90-degrees and an absolute value that differs from the second angle information by 90-degrees are in a range of between 10 degrees and 60 degrees.

17. The method of claim 11, wherein the recognizing of the location of the parking space includes recognizing the type of the parking space by recognizing the parking space through restoring at least a portion of a parking line that has been lost, and in a situation that the at least a portion of the parking line of the parking space is lost.

18. The method of claim 11, wherein the recognizing of the location of the parking space includes recognizing a type of a virtual parking space by recognizing the virtual parking space using surrounding information including information on a parked vehicle.

19. The method of claim 18, wherein the recognizing of the location of the parking space includes recognizing the virtual parking space by considering a location of a parking stopper and a location of the parked vehicle, in a situation that the parking stopper is detected.

20. The method of claim 11,
wherein the reference rotation matrix is a rotation matrix for a case where there is no gradient of a road surface, and
wherein the estimating of the gradient of the parking space includes estimating the gradient of the parking space based on a difference between the estimated rotation matrix and the reference rotation matrix.
